(19) United States
(12) Patent Application Publication
(10) Pub. No.: US 2004/0243769 A1
(43) Pub. Date: Dec. 2, 2004

(54) Tree based memory structure

(76) Inventors: David W. Frame, Phoenix, CA (US); Karl H. Mauritz, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/449,216

(22) Filed: May 30, 2003

(51) Int. Cl. G06F 12/00; G06F 13/00; G06F 3/00

(52) U.S. Cl. 711/148; 710/1

(57) ABSTRACT

A memory architecture with a tree based topology. Memory devices are paired with intelligent memory hubs that service memory access requests and manage data in the network of memory devices. Memory hubs can reconfigure the network topology dynamically to compensate for failed devices or the addition or removal of devices. The memory architecture can also support input output devices and be shared between multiple systems.

### FIELD OF THE INVENTION

Embodiments of the invention relate to the field of memory architecture. Specifically, embodiments of the invention relate to a tree based networked memory architecture.

### BACKGROUND

Conventional computer systems utilize a memory architecture with a limited ability to scale in terms of its storage capacity. Conventional memory architecture is unable to support more than sixty four gigabytes of memory. Several factors limit the ability of conventional memory architecture to scale beyond this limit. A significant factor limiting the scalability of memory architecture is the maintenance of signal integrity. Conventional memory architectures use repeater structures to extend the physical distance that a signal involved in addressing or controlling a memory device can be transmitted due to the natural distortion and weakening of signals through a conduit over a distance.

However, repeater structures increase the latency of a signal and still have an upper limit in terms of the total distance and therefore the total capacity of a memory architecture that can be supported. Repeater structures boost the strength of a signal in a single linear path. Repeater structures do not allow fan out for more than one communication channel. This limits the depth of the memory structure to a single level (i.e., chipset—repeater structure—memory device). Requests sent to a memory device over repeater structures in a conventional memory architecture must be sent one by one as the entire repeater channel acts as a single conduit. Thus, the entire length of the conduit is used when sending a request, preventing any other use until the request completes.

### BRIEF DESCRIPTION OF THE DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is a diagram of a system with a networked memory architecture.

FIG. 2a is a flowchart of an outbound initialization process.

FIG. 2b is a flowchart of an inbound initialization process.

FIG. 3 is a flowchart of a messaging process for hubs in a networked memory architecture.

### DETAILED DESCRIPTION

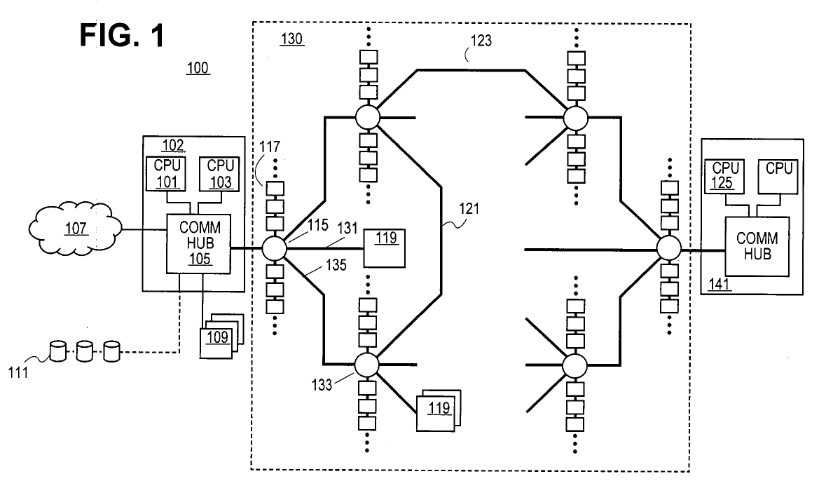

FIG. 1 is a block diagram of an exemplary system 100 utilizing a networked memory architecture. System 100 includes computer system 102. Computer system 102 may be a personal computer, server, workstation, mainframe or similar computer. Computer system 102 includes a central processing unit (CPU) 101 that executes programs embodied in a set of computer readable instructions. Computer system 102 may include additional CPUs 103 for multi-processing. CPU 101 is connected to a communication hub or communications chipset 105. Communications hub 105 manages communication between CPUs 101, 103 and memory subsystem 130, peripheral devices 109, storage devices 111, network communications 107 and similar subsystems. In one embodiment, communications hub 105 may be divided into several components such as a north bridge and a south bridge that divide the communications work between themselves.

In one embodiment, communications hub 105 is connected to memory subsystem 130 by an independent link with memory hub 115. In another embodiment, communications hub 105 may have several independent links to separate memory hubs. In one embodiment, communications hub 105 manages the configuration of the memory hubs in the memory subsystem 130. In another embodiment, the management of a memory subsystem 130 is primarily distributed amongst the memory hubs themselves. Communications hub 105 may maintain a forwarding table and track the topology of a memory subsystem 130.

In one embodiment, memory subsystem 130 is a tree based network. Communications hub 105 functions as the root of memory subsystem 130. Communications through memory subsystem 130 primarily originate or end with communications hub 105. Communications hub 105 generates the resource requests to memory subsystem 130 to service CPUs 101, 103, including sending messages for memory access (e.g, read and write commands), resource access (e.g, accessing devices connect to memory hubs) and to send instructions for operations to be executed by the memory hubs.

Memory hub 115 is connected to a set of memory devices 117. Memory devices 117 may be of any type or configuration including dual in line memory modules (DIMMS), single in line memory modules (SIMMS), static random access memory (SRAM), synchronous dynamic random access memory (SDRAM), double data rate random access memory devices (DDR RAM) and similar memory devices. Any number of memory devices 117 may be connected to hub 115 up to the physical constraints of the technology of the devices attached to hub 115.

Memory hub 115 may also include an input output port 131. Input output port 131 may be used to attach peripheral devices 119 to the memory subsystems 130. Input output devices 119 connected to memory hub 115 may be memory mapped devices, have an address space assigned to them or similarly interfaced with system 100 and memory subsystem 130. Each device linked to memory hub 115 has an independent link, including other memory hubs 133, input output devices 119 and communications hub 105. An independent link is a point to point link that is available when not transmitting or receiving a message between two end points. Thus, memory hub 115 may transmit or receive unrelated messages simultaneously on different links 131, 135.

In one embodiment, memory hub 115 may be an application specific integrated circuit (ASIC). Memory hub 115 may be capable of receiving instructions in messages and executing the instructions. Functions that may be performed by memory hub 115 may be specific or general depending on the complexity and processing capabilities of the ASIC. For example, memory hub 115 may execute a set of instructions that reorder the contents of memory devices 117 or that performs a computation or manipulation of data stored in memory devices 117. In one embodiment, memory hub 115 utilizes a portion of local memory devices 117 as a ‘scratch memory’ to carry out assigned operations. In one embodiment, instructions sent to memory hub 115 use multiphasic encoding methodology. Memory hubs 115 may be designed to perform a range of tasks from performing complex operations such as matrix operations on data in memory to only minimal memory and resource access tasks.

In one embodiment, memory hub 115 may be connected to any number of additional memory hubs. Additional memory hubs may be ASIC components identical to memory hub 115. Additional memory hubs have independent links with each connecting device such as input output device 119 and other memory hubs 115. Links to other memory hubs may also include redundant links 121. Redundant links 121 enable the reprogramming of the memory subsystem 130 to overcome disabled or malfunctioning hubs, links or memory devices. This reprogramming reroutes messages around the affected components and removes the components from the topography of the memory subsystem 130. In one embodiment, rerouting is accomplished by altering the forwarding tables kept by each memory hub and by communication hub 105. Links between memory hubs may be implemented using any physical architecture that supports point to point communications including optical mediums, flex cable, printed circuit board and similar technologies.

In one embodiment, memory hubs are connected to one another in a tree like topology. The root of the tree may be a memory hub 115 or communications hub 105. In one embodiment, communication hub 105 may function as the root of the tree network and actively manage memory subsystem 130 by directing the configuration of the memory hubs. In another embodiment, the functioning of the memory subsystem 130 is transparent to the communications hub 105. Communications hub 105 may send memory and resource requests only to a primary memory hub 115, which manages memory subsystem 130 or operates as part of a distributed management scheme. A communications hub 105 may be directly coupled to more than one memory hub 115.

A tree topology is a topology with a root node that branches out with any level of fanout to branch nodes and leaf nodes that may be any number of levels away from the root. In another embodiment, the topology of the network is a mesh, hybrid or similar topology. The topology of the network maybe cyclic or acyclic. An acyclic physical memory subsystem topology will include cycle checking or directed logical topology in memory hubs to prevent the sending of messages in circular paths.

While the topology may be generally tree structured, as mentioned, redundant links may be used to improve reliability and shorten the communication latency between memory hubs. In one embodiment, the topology includes multiple levels in a tree structure. Each level is determined by the length of the path to the communication hub 105 or root. For example, memory hub 115 is in a first level of the topology and memory hub 133 is in a second level of the topology. Memory hubs and memory devices in lower levels of the tree structure (i.e., those components closest to the root) have the shortest latency and those hubs and memory devices in the highest levels have the highest latency.

Thus, the memory subsystem 130 may be configured to prioritize memory usage based upon the importance or frequency of use for data and the level of a memory hub. Data that is most frequently accessed may be placed in lower levels while less frequently accessed data is placed in the higher levels of the topology. Thus, frequently used data can be retrieved with less latency and less frequently used data can be retrieved with a higher latency than the frequently used data. The topology will support memory sizes greater than sixty four gigabytes. Even the latency of data in higher levels is less than the retrieval times for data stored in fixed or removable storage devices such as hard disks, compact discs or similar media. Therefore, the overall system 100 retrieval times are improved over a conventional system with only a single layer of memory and smaller capacity of sixty four gigabytes or less, because more data can be stored in the memory subsystem reducing accesses to fixed or removable media which have access times that are orders of magnitude greater than memory access and because memory storage can be ordered on frequency of use basis improving access times similar to a cache.

In one embodiment, links between memory hubs may include links 123 that bridge two or more basic tree structured memory subsystems. Bridge links 123 can be used to network additional CPUs 125 and computer systems 141 to computer system 102. Bridging allows the sharing of memory space, address space, and system resources across multiple systems. The basic tree based messaging system and forwarding schemes used in a system 100 without a bridge 123 scale to operate on a bridged system 100. In one embodiment, each communications hub may act as a root and each maintains redundant topology data. In another embodiment, a single communications hub becomes a master communications hub and other communication hubs are slave devices carrying out assigned functions in maintaining the memory subsystem 130. In a further embodiment, the management is distributed among all memory hubs and communication hubs.

In one embodiment, memory hubs may communicate between themselves using any messaging protocol or set of instructions. ASICs in the memory hub are designed to interpret the message format and execute any instructions contained therein. In one embodiment, messages may be formatted packets or similar messages. In another embodiment, messages may be simple signals such as interrupts. In one embodiment, communication between the memory hubs, and communication hub 105 utilizes multiphasic encoding, language word based communications protocols or similar communications protocols.

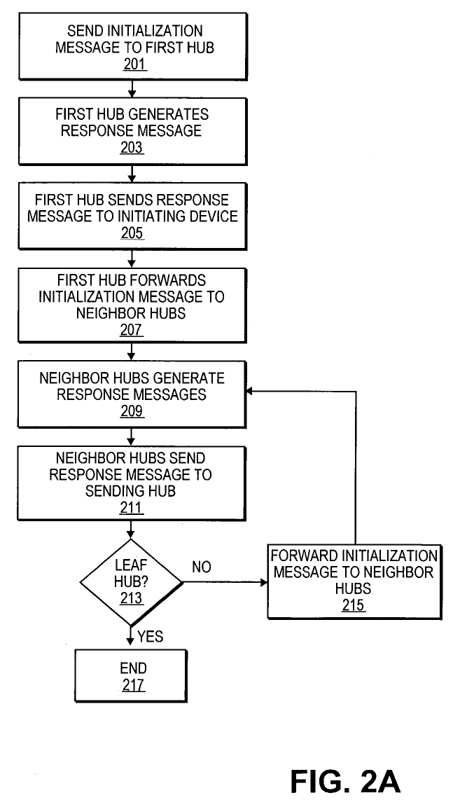

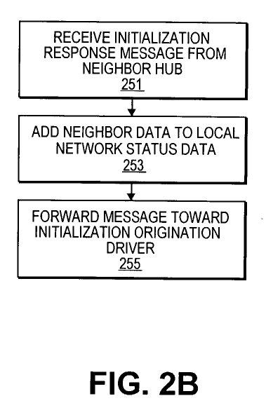

FIG. 2a is a flowchart of the processing of initialization messages in system 100 by memory hubs. The initialization phase occurs on system start up, restart or on similar events. The initialization phase may be started by communication hub 105 in computer system 102. A reinitialization may be started by a system 102 if an error arises or if the configuration of the memory subsystem 130 has changed. After a change in configuration is detected computer system 102 may start a reinitialization phase to determine the new configuration that has resulted. For example, the memory subsystem 130 supports ‘hot plugging’ of components or removal of components. In order to support ‘hot plugging’ and dynamic reconfiguration, data may be stored redundantly in multiple sets of memory devices 117 in memory subsystem 130. Memory subsystem 130 supports multiple physical memory locations for a single logical address. In another embodiment, the initialization phase may be initialized by a memory hub.

Communications hub 105 or memory hub 115 generates an initialization message on system 100 startup. This message is sent to the hubs in the first level of memory subsystem 130 (block 201). The message may have any format. The message prompts each receiving memory hub to generate a response message to be sent to the originator of the message (block 203). The response message contains basic configuration information regarding the hub generating the response message. Information contained in the message may include address space assigned to the memory devices connected to a hub, memory device types and characteristics, port information for the memory hub, neighbor hub information, topology information and similar information. In one embodiment, each memory hub independently assigns itself an address space during the initialization phase. Communications hub may arbitrate conflicting assignments or the hubs implement a distributed arbitration scheme for resolving conflicts. In another embodiment, the communications hub assigns address space to each hub or memory device in a centralized manner. Memory hubs may include electronically erasable and programmable read only memory devices (EEPROMs), or similar storage devices to maintain configuration data even when system 100 is powered down.

In one embodiment, the response message is sent to the device that originated the initialization request (block 205). The response message is sent through the device that delivered the initialization message. In one embodiment, after the response message has been sent the hub forwards the initialization message to each of its neighboring hubs (i.e., those hubs directly connected by a link with the memory hub) with the exception of the neighbor that sent the initialization message to the hub (block 207). In another embodiment, the hub forwards the initialization message at the same time as or before the generation of the response message. The memory hub may include data identifying itself in the forwarded message to build a stored path in the initialization message including each memory hub that forwarded the message so that the next memory hub that receives the message knows the path to send all response messages it receives back to the originating device. In another embodiment, each hub tracks initialization messages that are sent out to neighbor hubs to await a return response. The information tracked for each outgoing message includes forwarding information for the message such as the port of origin of the request, an identification tag for the message, and similar information.

Each neighbor hub receives the forwarded initialization message. The neighbor hub then generates a response message containing configuration data and similar data regarding the neighbor hub and its attached memory devices (block 209). The response message may also include an address space range assigned to the memory devices connected to a hub, memory device types and characteristics, port information for the memory hub, neighbor hub information, topology information and similar information.

Each neighbor sends its response message to the hub that forwarded the initialization message to it for ultimate delivery to the device that originated the initialization message (block 211). Each neighbor hub determines if it is a leaf hub (i.e., the hub has no neighbors except the hub that sent the initialization message) (block 211). If the neighbor hub is a leaf hub the process ends (block 217). However, if the neighbor hub has its own neighboring hubs then it forwards the initialization message to each of its neighboring hubs (block 215). The process repeats until all hubs have received the initialization message and sent a response message.

FIG. 2b is a flow chart of the processing of inbound messages during the initialization process. The message is received over an independent link from a neighboring memory hub (block 251). When any memory hub receives an inbound message (i.e., a response message from another memory hub destined for the originating device) the memory hub analyzes the message to add to its own local information about its neighbors and the topology of memory subsystem 130.

The hub examines the incoming message to record configuration data regarding the memory hub that generated the response message and any data recorded therein regarding other hubs or the topology of the memory subsystem 130 (block 253). In one embodiment, each memory hub that handles the response message adds data to the message relating to the path the message has taken such that the message contains complete path information identifying the memory hubs that lie between the root of the tree structured memory subsystem and the memory hub that generated the response. This data can be used by each memory hub that handles the message to identify the topology of the network that each hub maintains.

After recording the data in the message and altering the message to include any additional data the memory hub forwards the message toward the destination device, which originated the initialization message (block 255). The memory hub uses the tracking information stored when it received the initialization message to determine which of its neighbors to send the message to. This process coupled with the outbound messaging process supplies each memory hub with sufficient topology data to handle messages after initialization in its ‘branch’ of the tree structure. In one embodiment, the communication hub 105 gathers all the response data and is able to map out the entire topology of the memory subsystem 130. Communications hub 105 may also generate a set of configuration messages that send complete topology information to each of the memory hubs or to reconfigure the topology or settings of the hub.

Memory subsystem 130 organization may be optimized by grouping data along defined paths, over a set of layers or similar configurations based on memory usage, type of data, type of application associated with the data and similar groupings. In one embodiment, data may be organized in memory subsystem 130 such that related data may be stored across multiple memory hubs. If a portion of this data is accessed, the memory hubs may send messages to the other memory hubs indicating the access if the access also includes data stored in memory devices associated with those hubs. In one embodiment, data may be organized across hubs according to the latency of the hubs. Data frequently accessed may be stored in hubs with lower latency (lower layer hubs). Data across multiple hubs may be returned by a access request including caching of accessed data. In another embodiment, memory subsystem 130 organization may be optimized by grouping data according to the memory device type associated with a hub (e.g., DDR RAM, SDRAM or similar devices).

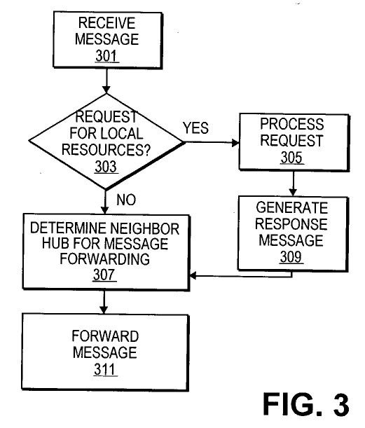

FIG. 3 is a flow chart for the process of handling messages by memory hubs during normal operation. Typical operations include read and write operations and input and output operations to input output devices 119. Most messages are sent between the communications hub 105 and the memory hubs in the lower levels of the memory subsystem. Most messages originate as resource requests from communication hub 105 and generate response messages from the memory hubs.

Each memory hub may receive a message over an independent link or channel from another memory hub or the communication hub 105 (block 301). The memory hub examines the message to determine if the destination address of the message or requested resource matches the address space range that the memory hub manages through memory devices 117 (block 303). If the message is intended for the memory hub, then the memory hub identifies the type of operation to be performed. The memory hub then processes the request (block 305). Requests may include memory access requests where the memory hub accesses the memory devices coupled to it. The message may also contain a set of instructions to be executed by the memory hub. Request messages may also request data from a port of the memory hub. In one embodiment, memory access or port data requests may be deferred by a memory hub. Memory or data access requests originating from any point in memory subsystem 130, communications hub 105 or other computer systems may be deferred to maintain open communication links. This allows the communications links between memory hubs to remain open for use while a memory hub retrieves requested data or performs an operation for the received request.

When the memory hub completes its processing of the request, it may generate a response message (block 309). Whether a response message is generated is dependent on the type of operation performed by the memory hub. For example, write operations may not require any response message from the memory hub. Read operations, however, may require the generation of a response message containing the requested data.

If a response message is generated or if the request message is destined for another memory hub then the memory hub checks the destination address of the message to determine how to forward the message (block 307). After the initialization phase each hub has topological information for its branch of the tree structure or the entire memory subsystem 130 stored within a storage device in the ASIC or in the memory devices 117. From the topological data the memory hub can generate a forwarding table or similar structure to map the addresses associated with each of its output ports. When a message arrives that is not destined for the memory hub the forwarding table is used to compare the destination address or resource identifier to determine the output port on which to forward the message. The message is then forwarded on that port (block 311). This process occurs at each memory hub until a message reaches its destination. This process applies to both inbound (i.e., messages intended for a root hub 115 or communication hub 105) and outbound (i.e., messages from the communication hub 105 to a memory hub) messages. In one embodiment, a response message may be an interrupt or similar signal that indicates that a task (e.g., a write request or the execution of a set of instructions, or similar request) has completed. Similarly, an interrupt or similar signal may be used by a memory hub or memory subsystem 130 to indicate that a memory address was accessed to facilitate security applications and debugging applications. Interrupts generated by memory subsystem 130 may be handled by a communications hub 105 or computer system 141 other memory hubs or similar systems.

In one embodiment, memory subsystem 130 supports detection and disabling of malfunctioning memory hubs or memory devices dynamically. This improves system 100 reliability and up time. A malfunctioning hub and memory unit or a neighbor of a non-responsive unit may generate an error message upon detecting an error or non-responsiveness of a component. In one embodiment, the error message may be sent to communication hub 105. Communication hub 105 can then send reconfiguration messages to the remaining memory hubs to reconfigure the network routing of messages until the malfunctioning unit is replaced. Communication hub 105 may also reinitialize the system 100 to affect the reconfiguration.

In one embodiment, communication hub 105 or memory hub may support broadcasting messages. Broadcasting sends a message to each neighbor except a neighbor that sent the message to the communication hub 105 or memory hub. Broadcasting is used during the initialization or reinitialization of the memory subsystem 130. Broadcasting may also be used during distributed reconfiguration to notify all hubs of a change in the configuration. In another embodiment, broadcast may be used to send messages containing instructions to be executed by each memory hub or in similar circumstances. For example, a broadcast message may be used to search all memory devices or a set of memory devices for a data item or parameter. When a memory hub locates the requested item in its associated memory devices it may generate a response message to the originator of the broadcast message. This enables parallel search of memory devices in memory subsystem 130.

System 100 is a distributed system that allows a limitless expansion of memory while maintaining signal integrity and latency management. Signal integrity is maintained because operations in the memory subsystem 130 operate by point to point messaging between hubs on independent communication links. The point to point communication of messages allows for error checking and retransmission of known messages between points instead of boosting signals over a long conduit path by repeater structures. System 100 also allows the sharing of a large memory space by multiple processor systems. System 100 is also suitable for stand alone machines such as desktop computers. System 100 improves reliability and accuracy by enabling redundant paths and redundant storage of data. System 100 facilitates security functions by supporting partitioning of memory, between computers, applications or operating systems sharing system 100. Partitions may be designated for the use of a single computer, user or application or for a group thereof. A partition or portion of memory may also be encrypted to protect it from unauthorized use. Similarly, system 100 supports encrypted communications between memory hubs and with the root hub. In one embodiment, system 100 supports the tracking of messaging to facilitate debugging and for use by security applications. In one embodiment, each hub and address space associated with a memory hub may have security access restrictions enforced by the memory hub. Security restriction may allow access only to a specific requesting user, application or system. In another embodiment, memory hub may restrict access based on a security key, code or similar mechanism. Unauthorized access may be tracked and interrupts may be generated to alert a system or communications hub 105 of any security violations or attempted security violations.

In the foregoing specification, the invention has been described with reference to specific embodiments thereof. It will, however, be evident that various modifications and changes can be made thereto without departing from the broader spirit and scope of the embodiments of the invention as set forth in the appended claims. The specification and drawings are, accordingly, to be regarded in an illustrative rather than a restrictive sense.

What is claimed is:

1. An apparatus comprising:
a first memory device to store data;
a first hub device coupled to the at least one memory device, the hub device to process memory access requests for the first memory device;
a second hub device coupled to the first hub device by a point to point link and the second memory device to process memory access requests for a second memory device; and
the second memory device to store data coupled to the second hub device.

2. The apparatus of claim 1, further comprising:
a third hub device coupled to the third memory device and the first hub device, the hub device to process memory access requests for a third memory device; and
the third memory device to store data coupled to the third hub device.

3. The apparatus of claim 1, wherein the first hub device to analyze a memory access request and determines an output port and to forward the memory access request to an output port.

4. The apparatus of claim 1, wherein the first hub device processes a set of instructions received in a message.

5. A system comprising:
a set of hub devices configured in a tree topology; and
a set of memory devices, each memory device coupled to a single hub device.

6. The system of claim 5, wherein each hub device is assigned an address space.

7. The system of claim 6, wherein each hub device analyzes a memory access request to determine if it applies to the assigned address space of the hub device.

8. A system comprising:
a first central processing unit;
a second central processing unit;
a first communications hub to manage communication between the first central processing unit, the second central processing unit and a first memory subsystem;
the first memory subsystem coupled to the first communications hub, the first memory subsystem including a first set of hub devices arranged in a tree topology; and
a set of memory devices, each memory device coupled to a hub device.

9. The system of claim 8, further comprising:
a second central processing unit;
a second communications hub to manage communication between the second central processing unit and a second memory subsystem;
the second memory subsystem coupled to the second communications hub, the second memory subsystem including a second set of hub devices; and
a link to connect the second memory subsystem to the first memory subsystem.

10. The system of claim 8, wherein the set of memory devices includes more than 64 gigabytes of storage space, and
wherein the set of memory devices is a set of random access memory modules.

11. The system of claim 8, wherein the first memory subsystem includes redundant links between hub devices.

12. The system of claim 8, wherein the hub device includes an input output port coupled to an input output device.

13. A method comprising:
sending an initialization message to a first memory hub device;
sending a response message, the response message including configuration data for the first memory hub device; and
forwarding the initialization message to a second memory hub device.

14. The method of claim 13, further comprising:
analyzing a response message from the second memory hub device by the first memory hub device.

15. The method of claim 13, wherein the response message includes data regarding a memory device coupled to the second memory hub device.

16. The method of claim 14, further comprising:
storing data related to a second hub device in a first memory hub device received in a response message.

17. The method of claim 13, further comprising:
forwarding the response message from a second hub device to an initialization message originating device.

18. A method comprising:
analyzing a resource request message by a first memory hub device;
determining if the first memory hub device can service the resource request; and
forwarding the resource request message to a second memory hub device, if the first memory hub device cannot service the request.

19. The method of claim 18, further comprising:
servicing the resource request message by the first memory hub device.

20. The method of claim 18, further comprising:
sending a response message to an originator of the resource request message.

21. The method of claim 20, wherein the response message contains requested data.

22. An apparatus comprising:
a means for saving data in a data storage network;
a means for retrieving data in the data storage network; and
a means for determining the location of data in the data storage network.

23. The apparatus of claim 22, wherein the data storage network has a tree topology.

24. The apparatus of claim 22, further comprising:
a means for configuring the data storage network.

25. A machine readable medium having stored therein instructions, which when executed cause a machine to perform a set of operations comprising:
analyzing a resource request message by a first memory hub device;
determining if the first memory hub device can service the resource request; and
forwarding the resource request message to a second memory hub device, if the first memory hub device cannot service the request.

26. The machine readable medium of claim 25, including further instructions, which when executed cause the machine to perform a set of operations further comprising:
executing a set of instructions by the first memory hub device.

27. The machine readable medium of claim 25, including further instructions, which when executed cause the machine to perform a set of operations further comprising:
moving data stored in a first memory device coupled to the first memory hub device to a second memory device coupled to a second memory hub device.
